(19) United States
(12) Patent Application Publication
(10) Pub. No.: US 2015/0097784 A1
(43) Pub. Date: Apr. 9, 2015

(54) MOBILE DEVICE AND DRIVING METHOD THEREOF

(71) Applicant: SAMSUNG ELECTRONICS CO., LTD., Suwon-si (KR)

(72) Inventors: Jong-oh LEE, Anyang-si (KR); Sang-Joon HYUNG, Seoul (KR); Seok-Hee HWANG, Seoul (KR)

(73) Assignee: SAMSUNG ELECTRONICS CO., LTD., Suwon-si (KR)

(21) Appl. No.: 14/289,131

(22) Filed: May 28, 2014

(30) Foreign Application Priority Data
Oct. 8, 2013 (KR) 10-2013-0119914

(51) Int. Cl. G06F 3/041

(52) U.S. Cl. CPC G06F 3/041
USPC 345/173

(57) ABSTRACT

Provided is a mobile device which includes: a first touch sensing panel (TSP) configured to receive a touch signal; a first touch sensor integrated circuit (TSIC) configured to activate the first TSP and determine a damage level of the first TSP; an application processor (AP) configured to control the first TSIC; and at least one second TSP configured to be activated by the AP or the first TSIC if it is determined that the first TSP is damaged in whole, wherein, if it is determined the first TSP is damaged in part, the AP activates a modified user interface (UI) in the first TSP which is different from a UI which is activated in the first TSP when the first TSP is not damaged.

### CROSS-REFERENCE TO RELATED APPLICATION

This application claims priority under 35 U.S.C. §119 from Korean Patent Application No. 10-2013-0119914 filed on Oct. 8, 2013, the disclosure of which is hereby incorporated by reference in its entirety.

### BACKGROUND

1. Field

Apparatuses and methods consistent with exemplary embodiments of the inventive concept relate to a mobile device, and more particularly, to a mobile device capable of driving an essential function or basic operation, and a driving method thereof when a touch sensor is damaged in whole or in part.

2. Description of Related Art

Smartphones, tablet personal computers (PCs) and personal digital assistants (PDAs) are being used as input means for inputting information through manipulation using a finger or pen on a touch sensor panel.

When a touch sensor panel part is damaged in a tablet PC or PDA, its essential functions including basic functions may not be available. Especially when the touch sensor panel has a window integrated touch sensor structure and a touch sensor is attached to a window covering glass, damage to the touch sensor panel is hardly cured.

When a mobile device such as a smartphone, tablet PC or PDA is dropped on the ground and the glass is broken, the touch sensor may not be operable. If the touch sensor is not operable, there will be much inconvenience to a user of the mobile device. For example, an emergency call cannot be made from the mobile device. Accordingly, methods to address these problems are required.

### SUMMARY

One or more exemplary embodiments of the inventive concept provide a mobile device capable of implementing an essential function when a touch sensor does not operate in whole or in part due to damage inflicted on a window covering glass of the mobile device.

One or more exemplary embodiments of the inventive concept also provide a method of driving the mobile device.

The technical objectives of the inventive concept are not limited to the disclosure herein, and other objectives may become apparent to those of ordinary skill in the art based on the following descriptions.

In accordance with an aspect of an exemplary embodiment of the inventive concept, there is provided a mobile device which may include: a first touch sensing panel (TSP) configured to receive a touch signal; a first touch sensor integrated circuit (TSIC) configured to activate the first TSP and determine a damage level of the first TSP; an application processor (AP) configured to control the first TSIC; and at least one second TSP configured to be activated by the AP or the first TSIC if it is determined that the first TSP is damaged in whole, wherein, if it is determined the first TSP is damaged in part, the AP activates a modified user interface (UI) in the first TSP which is different from a UI which is activated in the first TSP when the first TSP is not damaged.

The first TSIC may be connected to the first TSP through a first sensor line and configured to determine the damage level of the first TSP using the first sensor line.

The modified touch UI may include an application of an essential function of the mobile device.

The application of the essential function may include at least one of a phone-call sending and/or receiving application, a text sending and/or receiving application, an email application, and a camera application.

The device may further include a second TSIC that is connected to the second TSP through a second sensor line, and is configured to determine a damage level of the second TSP through the second sensor line, wherein the AP controls the second TSIC to activate the second TSP.

The first TSIC and the second TSIC may be connected to each other through a touch sensor line, and if it is determined that the first TSP is damaged in whole, the first TSIC may control the second TSIC through the touch line sensor to activate the second TSP.

The second TSP may be mounted on a side surface or rear surface of the mobile device.

If the first TSP is damaged, the touch signal may be input through the second TSP.

The AP is configured to control the first TSIC through a system bus which may include one of an Inter Integrated Circuit (I2C) bus and a Serial Peripheral Interface (SPI) bus.

In accordance with an aspect of another exemplary embodiments of the inventive concept, there is provided a method of driving a mobile device including first and second touch sensing panels (TSP) capable of receiving touch signals, a first TSIC connected to the first TSP through a first sensor line, and an application processor (AP) controlling the first TSIC. The method may include: determining a damage level of the first TSP; activating the second TSP if it is determined that the first TSP is damaged in whole; and implementing a modified user interface (UI) if it is determined that the first TSP is damaged in part.

The determining whether the damage level of the first TSP may be performed using the first sensor line by the first TSIC.

The determining the damage level of the first TSP may be performed by determining an amount, level or type of a signal that the first TSIC is able to receive from the first TSP through the first sensor line.

The activating the second TSP may include: connecting the first TSIC to the second TSIC through a touch sensor line; and controlling the second TSIC, by the first TSIC, to activate the second TSP through the touch sensor line if it is determined that the first TSP is damaged in whole.

The activating the modified UI may include implementing an application of an essential function of the mobile device.

The application of an essential function of the mobile device may include at least one of a phone-call sending and/or receiving application, a text sending and/or receiving application, an email application, and a camera application.

### BRIEF DESCRIPTION OF THE DRAWINGS

The foregoing and other features and advantages of the inventive concepts will be apparent from the more particular description of the exemplary embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram illustrating a mobile device in accordance with an exemplary embodiment;

FIG. 2 is a block diagram illustrating the mobile device illustrated in FIG. 1 in detail, according to an exemplary embodiment;

FIGS. 3A and 3B are views illustrating a second TSP mounted on a side surface of the mobile device illustrated in FIG. 1, according to exemplary embodiments;

FIG. 3C is a view illustrating the second TSP mounted on a rear surface of the mobile device in accordance with an exemplary embodiment;

FIG. 4A is a view illustrating a case in which a first TSP is damaged in whole, according to an exemplary embodiment;

FIG. 4B is a view illustrating a result after performing a touch operation through the second TSP when the first TSP is damaged in whole, according to an exemplary embodiment;

FIG. 5 is a block diagram illustrating a part of the mobile device illustrated in FIG. 1, according to an exemplary embodiment;

FIG. 6A is a view illustrating a case in which a touch sensor of the mobile device is damaged in part, according to an exemplary embodiment;

FIG. 6B is a view illustrating a result in which a modified touch UI is applied to the mobile device when a touch sensor is damaged in part, according to an exemplary embodiment;

FIG. 7 is a flowchart illustrating an operation driven by the mobile device in accordance with an exemplary embodiment;

FIG. 8 illustrates a computer system including the mobile device illustrated in FIG. 1, according to an exemplary embodiment;

FIG. 9 illustrates a computer system including the mobile device illustrated in FIG. 1, according to another exemplary embodiment; and

FIG. 10 illustrates a computer system including the mobile device illustrated in FIG. 1, according to still another exemplary embodiment.

### DETAILED DESCRIPTION OF THE EXEMPLARY EMBODIMENTS

Various exemplary embodiments will now be described more fully with reference to the accompanying drawings in which some embodiments are shown. The inventive concept may, however, be embodied in different forms and should not be construed as limited to the embodiments set forth herein. Rather, these embodiments are provided so that this disclosure is thorough and complete and fully conveys the inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The exemplary embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

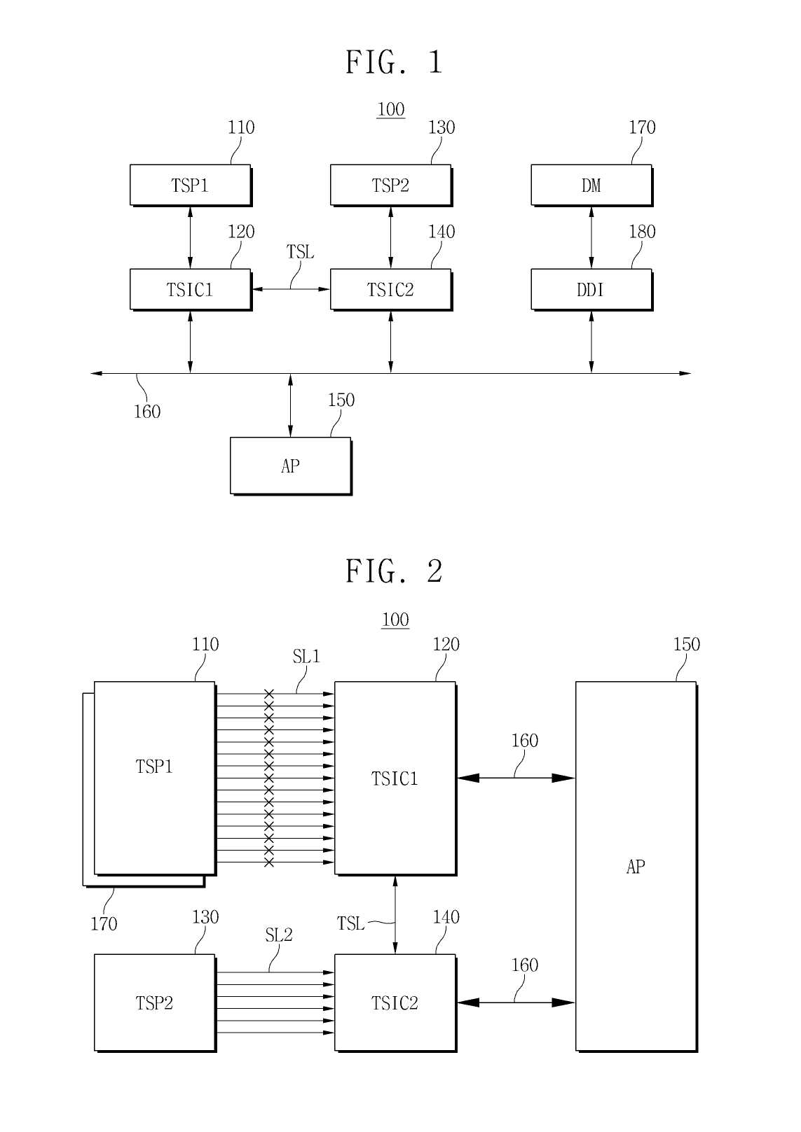

FIG. 1 is a block diagram illustrating a mobile device in accordance with an exemplary embodiment.

Referring to FIG. 1, a mobile device 100 includes a first touch sensing panel (TSP) 110, a first touch sensor integrated circuit (TSIC) 120, a second TSP 130, a second TSIC 140, an application processor (AP) 150, and a system bus 160.

In addition, the mobile device 100 may further include a display module (DM) 170 including a liquid crystal display (LCD), an active matrix organic light emitting diode (AMOLED), or the like that displays an image and a display driver integrated (DDI) circuit 180 configured to control the DM.

The first TSP 110 that is mounted on a front surface of the mobile device 100 may receive a touch input of a user. The first TSIC 120 may transmit the touch input received from the first TSP 110 to the AP 150 through the system bus 160.

The second TSP 130 that is mounted on a side surface or rear surface of the mobile device 100 may receive a touch input by a user. The second TSIC 140 may transmit the touch input received from the second TSP 130 to the AP 150 through the system bus 160.

Metal electrodes are distributed by being laminated on each of the first and second TSPs 110 and 130. Accordingly, when the user inputs a touch operation on the first or second TSP 110 or 130, there is a variation in a capacitance value between metal electrodes of the first TSP 110 or the second TSP 130. Then, the first TSP 110 or the second TSP 130 transmits the varied capacitance value to the first TSIC 120 or the second TSIC 140, respectively. The first TSIC 120 or the second TSIC 140 may change the varied capacitance value into an X-axis coordinate and a Y-axis coordinate, and transmit the coordinate value to the AP 150 or the DDI 180 through the system bus 160.

In addition, a touch sensor line TSL may be included between the first TSIC 120 and the second TSIC 140. Thus, the first TSIC 120 may activate the second TSIC 140 through the touch sensor line TSL.

The system bus 160 connects the first TSIC 120, the second TSIC 140, the AP 150 and the DDI 180 to one another to transmit data or a control signal therebetween. For example, the system bus 160 includes an Inter Integrated Circuit (I2C) bus, a Serial Peripheral Interface (SPI) bus or the like used for communication between chips.

The AP 150 may control the first TSIC 120 and the second TSIC 140 through the system bus 160. In general, an application processor used in the mobile device 100 includes Qualcomm's Snapdragon™, Samsung's Exynos™, NVidia's Tegra2™, or the like.

Only the first TSP 110 is activated while the mobile device 100 is in normal operation. However, when the first TSP 110 is damaged in whole due to an impact applied to the mobile device 100, the first TSP 110 no longer operates. In this case, when the first TSIC 120 recognizes that the first TSP 110 will not perform a normal operation, the first TSIC 120 transmits the determination of whether the first TSP 110 is out of order to the AP 150. Accordingly, in this case, the AP 150 controls the second TSIC 140 to activate the second TSP 130. Further, the first TSIC 120 may activate the second TSIC 140 through the touch sensor line TSL.

The user may perform an essential operation of the mobile device 100 through the second TSP 130. For example, the user may implement an emergency call application through the second TSP 130.

FIG. 2 is a block diagram illustrating the mobile device illustrated in FIG. 1 in detail, according to an exemplary embodiment.

Referring to FIG. 2, a DM 170 that displays an image in the mobile device 100 may be attached to the bottom of the first TSP 110. The first TSP 110 and the first TSIC 120 may be connected to each other through a first sensor line SL1. When the first TSP 110 is damaged in whole for reasons such as damage inflicted on a window covering glass, the first TSIC 120 cannot receive any signals through the first sensor line SL1. In this case, the first TSIC 120 determines that the first TSP 110 is damaged in whole.

In addition, the second TSP 130 and the second TSIC 140 may be connected to each other through a second sensor line SL2. The second TSIC 140 can determine whether the second TSP 130 is normal through the second sensor line SL2.

The first TSIC 120 may deliver the determined result to the AP 150 through the system bus 160. The AP 150 may control the second TSIC 140 to activate the second TSIC 140. Further, the first TSIC 120 may deliver the determined result to the second TSIC 140 through the touch sensor line TSL. Thereby, the second TSIC 140 can be activated.

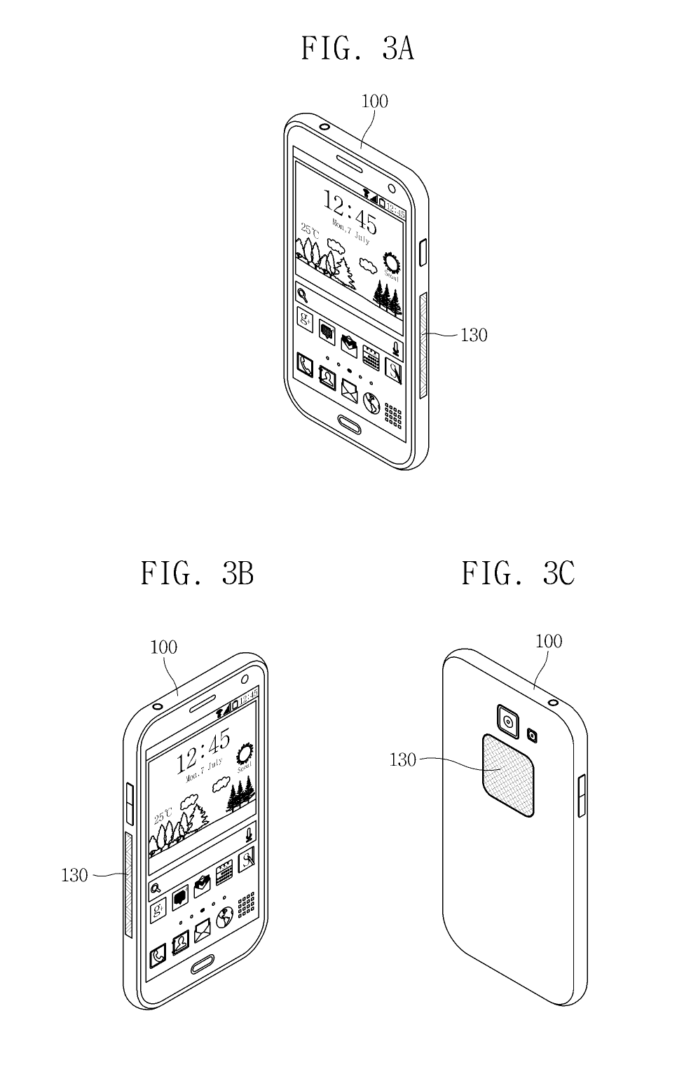

FIGS. 3A and 3B illustrate a second TSP mounted on a side surface of the mobile device illustrated in FIG. 1, according to exemplary embodiments.

Referring to FIG. 3A, the second TSP 130 may be mounted on a right side of the mobile device 100. When the first TSP 110 is damaged in whole, a user may input a touch signal through the second TSP 130 mounted on the right side of the mobile device 100.

Referring to FIG. 3B, the second TSP 130 may be mounted on a left side of the mobile device 100. When the first TSP 110 is damaged in whole, the user may input a touch signal through the second TSP 130 mounted on the left side of the mobile device 100.

In the above embodiments, the mobile device has two TSICs 120 and 140 respectively connected to the two TSPs 110 and 130. According to another exemplary embodiment, however, only one TSIC (e.g., the first TSIC 120) may be connected to the two TSPs 110 and 130 to perform all the functions of the two TSICs 120 and 140 described above. According to an exemplary embodiment, at least one of the two TSICs 120 and 140 may be implemented within the AP 150.

FIG. 3C is a view illustrating a second TSP mounted on a rear surface of the mobile device in accordance with an exemplary embodiment.

Referring to FIG. 3C, the second TSP 130 may be mounted on the rear surface of the mobile device 100. When the first TSP 110 is damaged in whole, the user may input the touch signal through the second TSP 130 mounted on the rear surface of the mobile device 100.

In the above embodiments, the mobile device 100 has only one second touch sensing panel TSP 130. According to another exemplary embodiment, however, the mobile device 100 may have two or more second touch sensing panels.

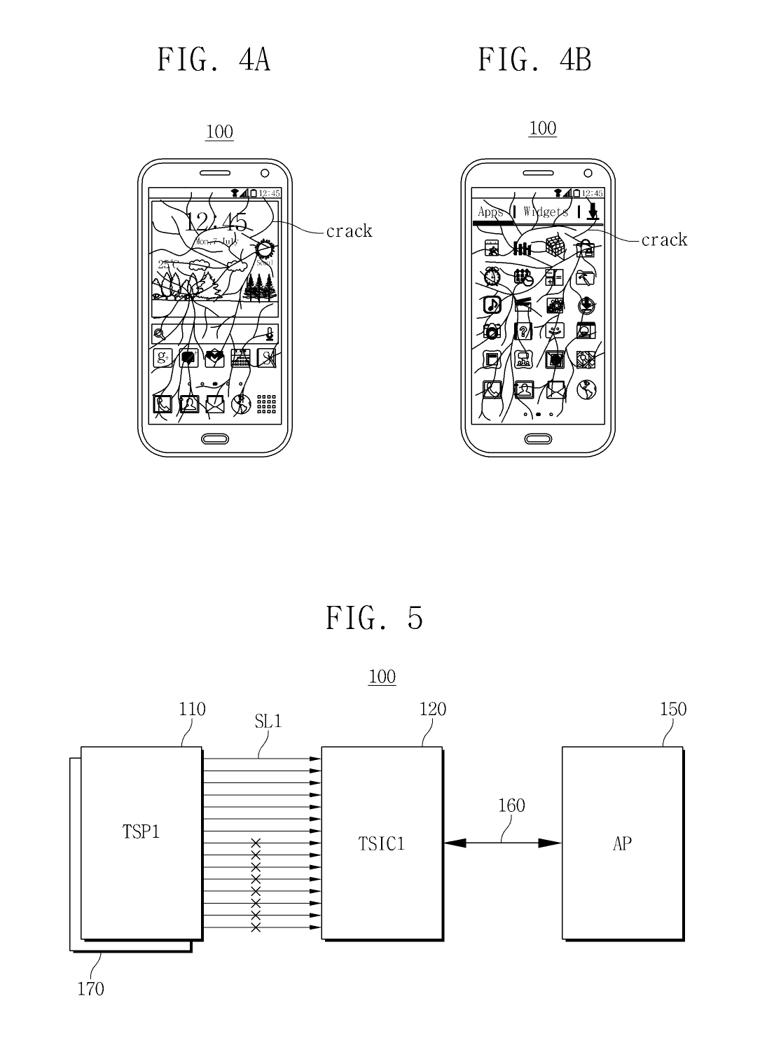

FIG. 4A illustrates a case in which the first TSP is damaged in whole, according to an exemplary embodiment.

Referring to FIG. 4A, a window covering glass is mounted on the front surface of the mobile device 100. The first TSP 110 will be mounted below the window covering glass. When the mobile device 100 is dropped on the ground, the mobile device 100 is impacted and the window covering glass and the first TSP 110 therebelow may be damaged in whole.

FIG. 4B illustrates a result after performing a touch operation through the second TSP when the first TSP is damaged in whole, according to an exemplary embodiment.

Referring to FIG. 4B, when the first TSP 110 is damaged in whole, the first TSIC 120 cannot receive any signals from the first TSP 110 through the first sensor line SL1. In this case, the first TSIC 120 determines that the first TSP 110 is damaged in whole.

When the first TSIC 120 recognizes that the first TSP 110 is not in normal operation, the first TSIC 120 transmits the determination of whether the first TSP 110 is out of order to the AP 150. Accordingly, in this case, the AP 150 may control the second TSIC 140 to activate the second TSP 130. Further, the first TSIC 120 may activate the second TSIC 140 through the touch sensor line TSL.

When the first TSP 110 is damaged in whole, the user may input a touch signal through the second TSP 130 mounted on a side or rear surface of the mobile device 100. Accordingly, the user can perform an essential function of the mobile device 100.

FIG. 5 is a block diagram illustrating a part of the mobile device illustrated in FIG. 1, according to an exemplary embodiment.

Referring to FIG. 5, the DM 170 that displays an image in the mobile device 100 may be attached to the bottom of the first TSP 110. The first TSP 110 and the first TSIC 120 may be connected to each other through the first sensor line SL1. However, when the first TSP 110 is damaged in part for reasons such as damage inflicted on a window covering glass, the first TSIC 120 may receive some signals through the first sensor line SL1. In this case, the first TSIC 120 determines that the first TSP 110 is damaged in part. The first TSIC 120 may deliver the determined result to the AP 150 through the system bus 160. Accordingly, the AP 150 implements a modified touch user interface (UI).

According to another exemplary embodiment, the first TSIC 120 may determine whether the first TSP 110 is damaged in part or in whole based on an amount, level or type of a signal that the first TSIC is able to receive from the first TSP.

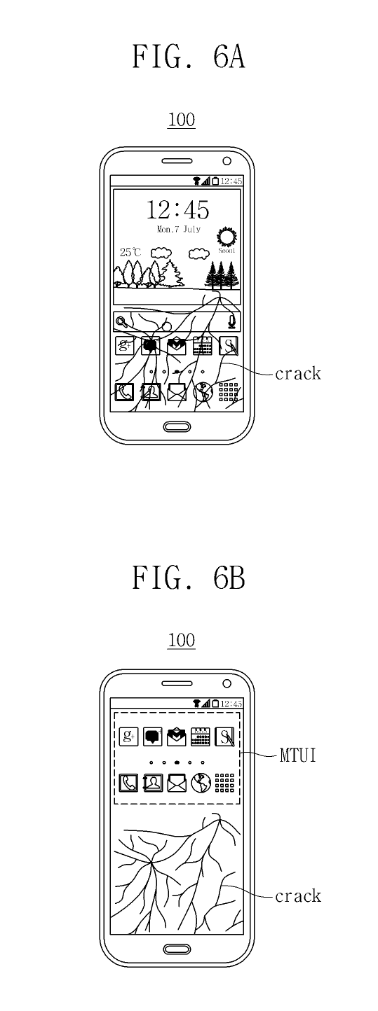

FIG. 6A illustrates a case in which a touch sensor of the mobile device is damaged in part, according to an exemplary embodiment.

Referring to FIG. 6A, a window covering glass may be mounted on the front surface of the mobile device 100. The first TSP 100 will be mounted below the window covering glass. When the mobile device 100 is dropped on the ground, the mobile device 100 is impacted and the window cover glass and the first TSP 110 therebelow may be damaged in part.

FIG. 6B illustrates a result in which a modified touch UI is applied to the mobile device when a touch sensor is damaged in part, according to an exemplary embodiment.

Referring to FIG. 6B, when the first TSP 110 is damaged in part, the first TSIC 120 may receive some signals from the first TSP 110 through the first sensor line SL1. In this case, the first TSIC 120 determines that the first TSP 110 is damaged in part.

When the first TSIC 120 recognizes that the first TSP 110 is not in normal operation, the first TSIC 120 transmits the determination of whether the first TSP 110 is out of order to the AP 150. Accordingly, in this case, the AP 150 implements a modified touch UI (MTUI), that is, the AP 150 implements the MTUI on the remaining area of the first TSP 110, which is not damaged.

When the first TSP 110 is damaged in part, a user inputs a touch signal through the MTUI. Thereby, the user performs an essential function of the mobile device 100. The essential function may include a phone-call sending and/or receiving application, a text sending and/or receiving application, an email application, and a camera application.

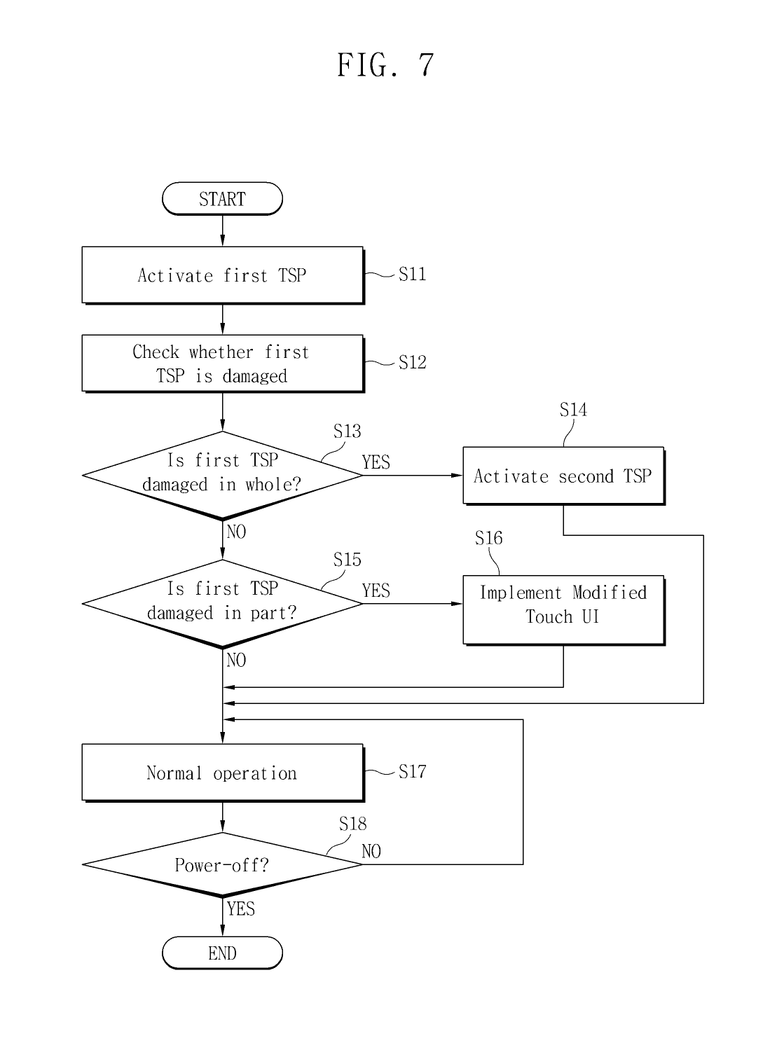

FIG. 7 is a flowchart illustrating an operation driven by the mobile device 100 in accordance with an exemplary embodiment.

Referring to FIGS. 1, 2, 5 and 7, in operation S11, when the mobile device 100 is powered on, the mobile device 100 activates the first TSP 110 in accordance with a power-on process.

In operation S12, the first TSIC 120 checks whether the first TSP 110 is damaged. For example, when the first TSP 110 is damaged in whole, the first TSIC 120 cannot receive any signals from the first TSP 110 through the first sensor line SL1. In this case, the first TSIC 120 determines that the first TSP 110 is damaged in whole. On the other hand, when the first TSP 110 is damaged in part, the first TSIC 120 receives some signals from the first TSP 110 through the first TSP 110. Accordingly, in this case, the first TSIC 120 determines that the first TSP 110 is damaged in part.

In operation S13, when the first TSP 110 is damaged in whole, operation S14 is performed. Otherwise, operation S15 is performed.

In operation S14, the first TSIC 120 or the AP 150 activates the second TSP 130.

In operation S15, when the first TSP 110 is damaged, operation S16 is performed. Otherwise, operation S17 is performed.

In operation S16, the AP 150 implements an MTUI.

In operation S17, the mobile device 100 performs a normal operation.

In operation S18, when a power-off instruction is input, the mobile device 100 is powered off, and thus an operation of the mobile device 100 ends.

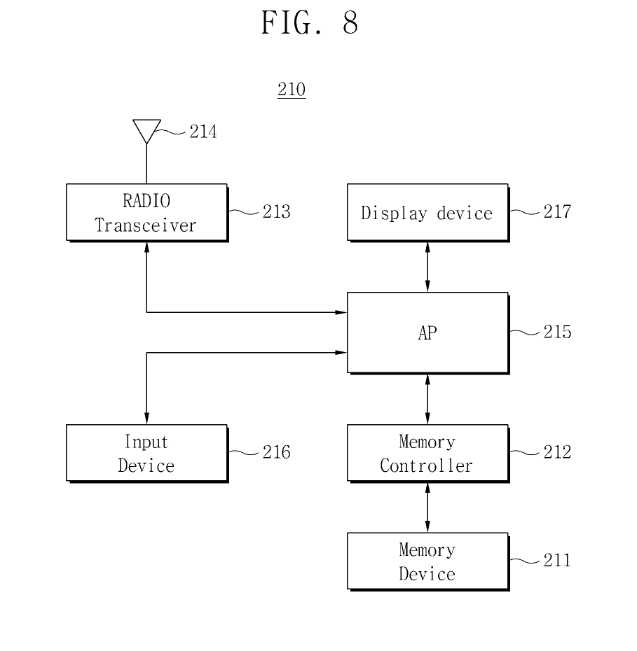

FIG. 8 illustrates a computer system including the mobile device illustrated in FIG. 1, according to an exemplary embodiment.

Referring to FIG. 8, a computer system 220 may be implemented by a smartphone, a personal digital assistant (PDA) equipped with a communication function, a portable multimedia player (PMP), and the like.

The computer system 210 includes a memory device 211, a memory controller 212 that controls the memory device 211, a wireless transceiver 213, an antenna 214, an application processor 215, an input device 216, and a display device 217.

The wireless transceiver 213 may transmit and receive wireless signals through the antenna 214. For example, the wireless transceiver 213 may change the wireless signals received through the antenna 214 into signals that can be processed in the application processor 215.

Accordingly, the application processor 215 may process the signals output from the wireless transceiver 213, and transmit the processed signals to the display device 217. In addition, the wireless transceiver 213 may change signals output from the application processor 215 into wireless signals, and output the changed wireless signals to external devices through the antenna 214.

The input device 216, which serves as a device capable of inputting a control signal so as to control an operation of the application processor 215 or inputting data to be processed by the application processor 215, may be implemented by a touch pad, a pointing device such as a computer mouse, a keypad, or a keyboard.

In some embodiments, the memory controller 212 capable of controlling an operation of the memory device 211 may be implemented as a part of the application processor 215, and may also be implemented as a separate chip from the application processor 215.

In some embodiments, the mobile device 100 illustrated in FIG. 1 may be implemented as a smartphone.

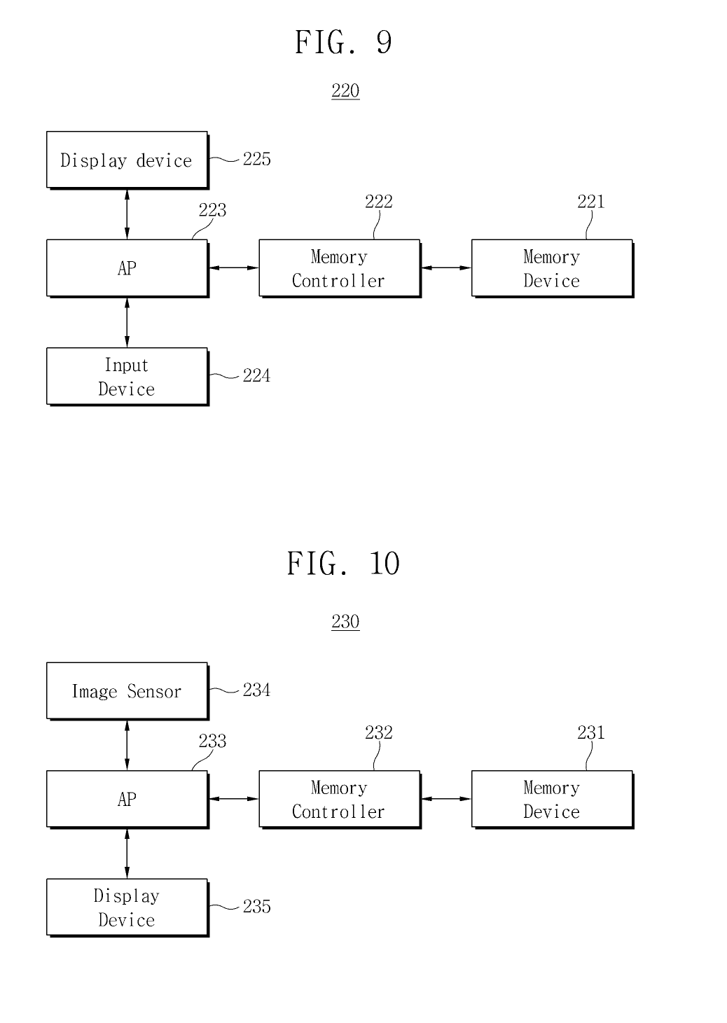

FIG. 9 illustrates a computer system including the mobile device illustrated in FIG. 1, according to another exemplary embodiment.

Referring to FIG. 9, the computer system 220 may be implemented by a personal computer (PC), a network server, a tablet PC, a net-book, an e-reader, a PDA, a PMP, an MP3 player, or an MP4 player.

The computer system 220 includes a memory device 221, a memory controller 222 capable of controlling a data processing operation of the memory device 221, an application processor 223, an input device 224, and a display device 225.

The application processor 223 may display data that is stored in the memory device 221 through the display device 225 depending on data input through the input device 224. For example, the input device 224 may be implemented by a touch pad, a pointing device such as a computer mouse, a keypad, or a keyboard. As such, the application processor 223 may control the overall operation of the computer system 220, and control the operation of the memory controller 222.

In some embodiments, the memory controller 222 capable of controlling an operation of the memory device 221 may be implemented as a part of the application processor 223, and may also be implemented by a separate chip from the application processor 223.

In some embodiments, the mobile device 100 illustrated in FIG. 1 may be implemented by a tablet PC.

FIG. 10 illustrates a computer system including the mobile device illustrated in FIG. 1, according to still another exemplary embodiment.

Referring to FIG. 10, the computer system 230 may be implemented by an image processing device, for example, a digital camera, a mobile phone with a digital camera attached, a smartphone, or a tablet PC.

The computer system 230 includes a memory device 231 and a memory controller 232 capable of controlling a data processing operation of the memory device 231, for example, a write operation or read operation. In addition, the computer system includes an application processor 233, an image sensor 234, and a display device 235.

The image sensor of the computer system 230 converts optical images into digital signals, and then the converted digital signals are transmitted to the application processor 233, or to the memory controller 232. Depending on a control of the application processor 233, the converted digital signals may be either displayed through the display device 235 or saved in the memory device 231 through the memory controller 232.

Further, the data stored in the memory device 231 may be displayed through the display device 235 depending on the control of the application processor 233, or the memory controller 232.

In some embodiments, the memory controller 232 capable of controlling an operation of the memory device 231 may be implemented as a part of the application processor 233, and may also be implemented by a separate chip from the application processor 233.

In some embodiments, the mobile device illustrated in FIG. 1 may be implemented by a digital camera such as a Galaxy Camera™, and a Galaxy S4 Zoom™.

Accordingly, the mobile device in accordance with the above embodiments of the inventive concept can perform an essential function by providing a second touch sensing panel sensor or an MTUI when the mobile device cannot perform a normal operation due to damage inflicted on a touch sensor in whole or in part.

The foregoing is illustrative of exemplary embodiments of the inventive concept and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A mobile device comprising:
a first touch sensing panel (TSP) configured to receive a touch signal;
a first touch sensor integrated circuit (TSIC) configured to activate the first TSP and determine a damage level of the first TSP; an application processor (AP) configured to control the first TSIC; and
at least one second TSP configured to be activated by the AP or the first TSIC if it is determined that the first TSP is damaged in whole,
wherein, if it is determined the first TSP is damaged in part, the AP activates a modified user interface (UI) in the first TSP which is different from a UI which is activated in the first TSP when the first TSP is not damaged.

2. The mobile device according to claim 1, wherein the first TSIC is connected to the first TSP through a first sensor line and configured to determine the damage level of the first TSP using the first sensor line.

3. The mobile device according to claim 1, wherein the first TSIC determines whether the first TSP is damaged in whole or in part based on an amount, level or type of a signal that the first TSIC is able to receive from the first TSP.

4. The mobile device according to claim 1, wherein the modified UI includes a UI for an application of a predetermined function of the mobile device.

5. The mobile device according to claim 4, wherein the application of the predetermined function includes at least one of a phone-call sending and/or receiving application, a text sending and/or receiving application, an email application, and a camera application.

6. The mobile device according to claim 1, further comprising:
a second TSIC that is connected to the second TSP through a second sensor line, and is configured to determine a damage level of the second TSP through the second sensor line,
wherein the AP is configured to control the second TSIC to activate the second TSP.

7. The mobile device according to claim 6, wherein the first TSIC and the second TSIC are connected to each other through a touch sensor line; and
wherein, if it is determined that the first TSP is damaged in whole, the first TSIC controls the second TSIC through the touch sensor line to activate the second TSP.

8. The mobile device according to claim 1, wherein the second TSP is mounted on a side surface or rear surface of the mobile device.

9. The mobile device according to claim 1, wherein the second TSP is configured to provide a UI for an application of a predetermined function of the mobile device.

10. The mobile device according to claim 1, wherein the AP is configured to control the first TSIC through a system bus that includes at least one of an Inter Integrated Circuit (I2C) bus and a Serial Peripheral Interface (SPI) bus.

11. The mobile device according to claim 1, wherein the modified US is activated in a part of the first TSP which is not damaged.

12. A method of driving a mobile device including first and second touch sensing panels (TSPs) capable of receiving touch signals, a first touch sensor integrated circuit (TSIC) connected to the first TSP through a first sensor line, and an application processor (AP) controlling the first TSIC, the method comprising:
determining a damage level of the first TSP;
activating the second TSP if it is determined that the first TSP is damaged in whole; and
implementing a modified user interface (UI) if it is determined that the first TSP is damaged in part.

13. The method according to claim 12, wherein the determining whether the damage level of the first TSP is performed using the first sensor line by the first TSIC.

14. The method according to claim 12, wherein the determining the damage level of the first TSP comprises determining an amount, level or type of a signal that the first TSIC is able to receive from the first TSP through the first sensor line.

15. The method according to claim 12, wherein the activating the second TSP comprises:
connecting the first TSIC to the second TSIC through a touch sensor line; and
controlling the second TSIC, by the first TSIC, to activate the second TSP through the touch sensor line if it is determined that the first TSP is damaged in whole.

16. The method according to claim 12, wherein the activating the modified UI comprises providing a UI for an application of a predetermined function of the mobile device.

17. The method according to claim 16, wherein the application of the predetermined function of the mobile device comprises at least one of a phone-call sending and/or receiving application, a text sending and/or receiving application, an email application, and a camera application.

18. A mobile device comprising:
a main touch sensing panel (TSP) configured to receive a touch signal;
at least one secondary TSP configured to receive the touch signal; and
a processor configured to determine a damage level of the main TSP and selectively control the main TSP or the secondary TSP to process the touch signal according to a result of the determination.

19. The mobile device of claim 18, if the processor determines that the main TSP is damaged in whole, the processor controls the secondary TSP to provide s user interface (UI) for an application for a predetermined function.

20. The mobile device of claim 19, if the processor determines that the main TSP is damaged in part, the processor controls the main TSP to provide a user interface (UI) for an application for a predetermined function through a modified UI which is different from a UI which is provided in the first TSP when the first TSP is not damaged.
